(19) United States
(12) Patent Application Publication
(10) Pub. No.: US 2025/0069435 A1
(43) Pub. Date: Feb. 27, 2025

(54) AUTHENTICATION APPARATUS, SYSTEM, METHOD, AND COMPUTER READABLE MEDIUM

(71) Applicant: NEC Corporation, Minato-ku, Tokyo (JP)

(72) Inventor: Yuta Shimizu, Tokyo (JP)

(73) Assignee: NEC Corporation, Mintato-ku, Tokyo (JP)

(21) Appl. No.: 18/725,378

(22) PCT Filed: Jan. 24, 2022
(86) PCT No.: PCT/JP2022/002418

§ 371 Date: Jun. 28, 2024

(51) Int. Cl. G06V 40/16; G06V 40/50

(52) U.S. Cl. CPC G06V 40/172; G06V 40/166; G06V 40/50

(57) ABSTRACT

A face image acquisition means acquires a face image of a person to be authenticated. An authentication means performs a first authentication of collating the face image of the person to be authenticated with a registered image of a registrant. When the first authentication has been successful, the authentication means stores the face image of the person to be authenticated in a face information storage unit as face information regarding which authentication of the registrant has been successful. When the first authentication has failed, the authentication means performs a second authentication including collation of the face image of the person to be authenticated with face information regarding which the authentication has been successful and which is stored in the face information storage unit.

### TECHNICAL FIELD

The present disclosure relates to an authentication apparatus, a system, a method, and a computer readable medium.

### BACKGROUND ART

As related art, Patent Literature 1 discloses an authentication apparatus. The authentication apparatus disclosed in Patent Literature 1 acquires, from an image-capturing device, a plurality of images of a subject that are continuous along a time series. The authentication apparatus compares each of the plurality of images with a registered image to determine whether or not each image matches the registered image. When the number of times it is determined continuously that the images match the registered image is equal to or larger than a set number, the authentication apparatus registers images that are not determined to match the registered image in association with the registered image.

For example, the image-capturing device continuously captures an image of one person A and continuously acquires face image data of the person A along the time series. The authentication apparatus acquires N pieces of face image data of the person A from the image-capturing device, N being any natural number. The authentication apparatus collates each of the N pieces of face image data with a master (registered image) of the person A. When features of each of the pieces of face image data from N-2 to N that are continuous along the time series match the features of the master of the person A, the authentication apparatus authenticates that the captured person is the person A.

When features of each of the pieces of face image data from N-2 to N match the features of the master of the person A, it is highly likely that a person in face image data at and before N-3 is, even if authentication of this person has failed, the person A as well. The authentication apparatus calculates a matching rate of each of the pieces of face image data at and before N-3 with the face image data at N-2. The authentication apparatus additionally registers face image data regarding which the matching rate is equal to or larger than a threshold among the pieces of face image data which have failed to be authenticated as the master of the person A.

### CITATION LIST

### Patent Literature

[Patent Literature 1] Japanese Unexamined Patent Application Publication No. 2018-169776

### SUMMARY OF INVENTION

### Technical Problem

In Patent Literature 1, the authentication apparatus additionally registers, as the registered image, face image data with a high matching rate with the face image data which has been successfully authenticated among the pieces of face image data which have failed to be authenticated. According to Patent Literature 1, by increasing the number of registered images, the probability of authentication failure can be reduced and the authentication rate can be improved. However, according to Patent Literature 1, a plurality of registered images are always used for each person who is to be authenticated. Therefore, the number of times collation processing in the authentication has to be performed increases, which causes the time required for authentication to increase.

The present disclosure has been made in view of the aforementioned circumstances and an aim of the present disclosure is to provide an authentication apparatus, a system, a method, and a computer readable medium capable of reducing the probability of authentication failure without increasing the number of times collation has to be performed.

### Solution to Problem

In order to attain the aforementioned object, the present disclosure provides an authentication apparatus as a first aspect. The authentication apparatus includes: face image acquisition means for acquiring, from a captured image acquired from an image-capturing device that captures an image of a person to be authenticated, a face image of the person to be authenticated; and authentication means for performing a first authentication for collating the acquired face image of the person to be authenticated or features extracted from the face image with a registered image of a registrant or features extracted from the registered image. The authentication means stores, when the first authentication has been successful, the face image of the person to be authenticated or the features extracted from the face image in a face information storage unit as face information regarding which authentication of the registrant has been successful. The authentication means performs, when the first authentication has failed, a second authentication including collating the face image of the person to be authenticated or the features extracted from the face image with face information regarding which the authentication has been successful and which is stored in the face information storage unit.

The present disclosure provides an authentication system as a second aspect. The authentication system includes an image-capturing device that captures an image of a person to be authenticated and an authentication apparatus configured to acquire the image captured by the image-capturing device and authenticate the person to be authenticated. The authentication apparatus includes: face image acquisition means for acquiring a face image of the person to be authenticated from the captured image; and authentication means for performing a first authentication for collating the acquired face image of the person to be authenticated or features extracted from the face image with a registered image of a registrant or features extracted from the registered image. The authentication means stores, when the first authentication has been successful, the face image of the person to be authenticated or the features extracted from the face image in a face information storage unit as face information regarding which authentication of the registrant has been successful. The authentication means performs, when the first authentication has failed, a second authentication including collating the face image of the person to be authenticated or the features extracted from the face image with face information regarding which the authentication has been successful and which is stored in the face information storage unit.

The present disclosure provides an authentication method as a third aspect. The authentication method includes: acquiring a face image of a person to be authenticated from a captured image acquired from an image-capturing device that captures an image of the person to be authenticated; performing a first authentication for collating the acquired face image of the person to be authenticated or features extracted from the face image with a registered image of a registrant or features extracted from the registered image; determining whether or not the first authentication has been successful; storing, when it is determined that the first authentication has been successful, the face image of the person to be authenticated or the features extracted from the face image in a face information storage unit as face information regarding which authentication of the registrant has been successful; and performing, when it is determined that the first authentication has failed, a second authentication including collating the face image of the person to be authenticated or the features extracted from the face image with face information regarding which the authentication has been successful and which is stored in the face information storage unit.

The present disclosure provides a computer readable medium as a fourth aspect. The computer readable medium stores a program for causing a computer to perform processing including: acquiring a face image of a person to be authenticated from a captured image acquired from an image-capturing device that captures an image of the person to be authenticated; performing a first authentication for collating the acquired face image of the person to be authenticated or features extracted from the face image with a registered image of a registrant or features extracted from the registered image; determining whether or not the first authentication has been successful; storing, when it is determined that the first authentication has been successful, the face image of the person to be authenticated or the features extracted from the face image in a face information storage unit as face information regarding which authentication of the registrant has been successful; and performing, when it is determined that the first authentication has failed, a second authentication including collating the face image of the person to be authenticated or the features extracted from the face image with face information regarding which the authentication has been successful and which is stored in the face information storage unit.

### Advantageous Effects of Invention

According to an authentication apparatus, a system, a method, and a computer readable medium of the present disclosure, it is possible to reduce the probability of authentication failure without increasing the number of times collation has to be performed.

### BRIEF DESCRIPTION OF DRAWINGS

FIG. 1 is a block diagram schematically showing an authentication system according to the present disclosure;

FIG. 2 is a block diagram showing an authentication system according to one example embodiment of the present disclosure;

FIG. 3 is a diagram showing an example of face information stored in a face information storage unit;

FIG. 4 is a flowchart showing an operation procedure in an authentication apparatus;

FIG. 5 is a schematic view schematically showing a first face authentication;

FIG. 6 is a schematic view schematically showing a second face authentication; and

FIG. 7 is a block diagram showing an example of a hardware configuration of the authentication apparatus.

### EXAMPLE EMBODIMENT

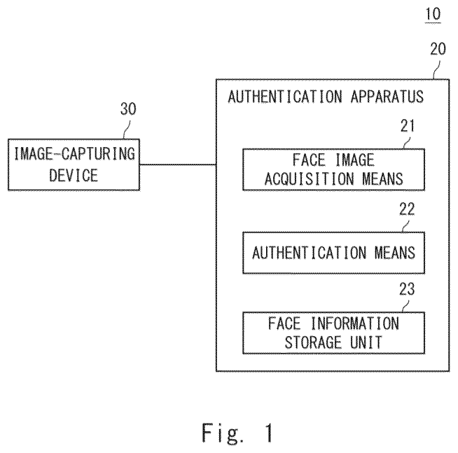

Prior to giving the description of an example embodiment of the present disclosure, an outline of the present disclosure will be described. FIG. 1 schematically shows an authentication system according to the present disclosure. An authentication system 10 includes an authentication apparatus 20 and an image-capturing device 30. The image-capturing device 30 captures an image of a person to be authenticated. The authentication apparatus 20 acquires the image captured by the image-capturing device 30 and authenticates the person to be authenticated.

The authentication apparatus 20 includes a face image acquisition means 21 and an authentication means 22. The face image acquisition means 21 acquires a face image of the person to be authenticated from the image captured by the image-capturing device 30. The authentication means 22 executes a first authentication and collates the face image of the person to be authenticated with a registered image of a registrant. The authentication means 22 may collate, in the first authentication, features extracted from the face image of the person to be authenticated with features of the registrant extracted from the registered image.

When the first authentication has been successful, the authentication means 22 stores the face image of the person to be authenticated or the features extracted from the face image in a face information storage unit 23 as face information regarding which authentication of the registrant has been successful. When the first authentication has failed, the authentication means 22 executes a second authentication. The authentication means 22 collates, in the second authentication, the face image or features of the person to be authenticated with the face image or features regarding which authentication has been successful and which is stored in the face information storage unit 23.

In the present disclosure, the authentication means 22 stores the face image or features of the person to be authenticated regarding which the first authentication has been successful in the face information storage unit 23. The authentication means 22 acquires, when the first authentication has failed, the face image or features of the person to be authenticated regarding which the first authentication has been successful in the past from the face information storage unit 23 and collates the face image or features of the person to be authenticated with the face image or features acquired from the face information storage unit 23. The face image acquired from the face information storage unit 23 is an image regarding which the first authentication has been successful in the past and which has been captured using the image-capturing device 30. When the first authentication has failed, collation is performed using the aforementioned images, whereby it is possible to reduce the probability of authentication failure in the second authentication. Further, in the present disclosure, the face image or features stored in the face information storage unit 23 is used when the first authentication has failed. Accordingly, it is possible to reduce the probability of authentication failure while preventing the number of times collation has to be performed from increasing compared to a case in which images or features regarding which authentication has been successful in the past are always used.

Hereinafter, with reference to the drawings, the example embodiment of the present disclosure will be described in detail. For the sake of clarification of the explanation, the following descriptions and drawings are omitted and simplified as appropriate. In each drawing, the same and similar elements have the same reference signs, and repeated descriptions have been omitted as appropriate.

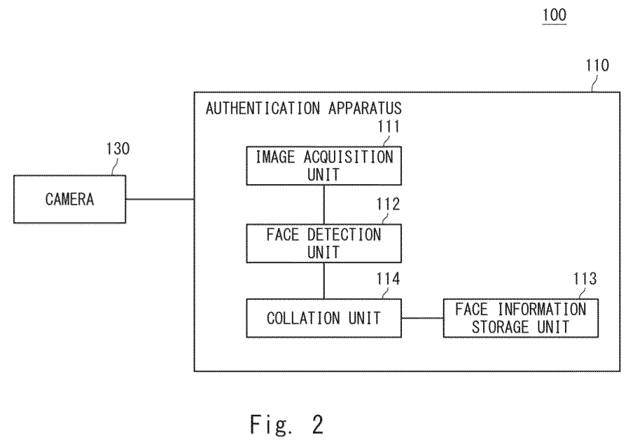

FIG. 2 shows an authentication system according to one example embodiment of the present disclosure. An authentication system 100 includes an authentication apparatus 110 and a camera 130. In the following description, an example in which the authentication system 100 is used for vehicle interior entry in a vehicle such as an automobile will be described. The authentication system 100 is not limited to being applied to vehicle interior entry and may be applied to authentication in various systems. The authentication system 100 corresponds to the authentication system 10 shown in FIG. 1.

The camera 130 captures an image of a person to be authenticated (subject). It is assumed that the camera 130 captures an image of a subject who is outdoors in this example embodiment. The camera 130 captures, for example, an image of a person who is going to get on the vehicle. The vehicle is, for example, a mobile body such as an automobile, a taxi, or a wagon. The camera 130 is mounted on, for example, a vehicle and captures an image of the subject who is outside the vehicle from the inside the vehicle. The camera 130 may be mounted outside the vehicle and capture an image of a subject who approaches the vehicle. In the authentication system 100, the number of cameras 130 is not limited to one. The authentication system 100 may include a plurality of cameras 130. The camera 130 corresponds to the image-capturing device 30 shown in FIG. 1.

The authentication apparatus 110 is an apparatus that acquires a video image of a subject from the camera 130 and performs authentication using the acquired video image. The authentication apparatus 110 is mounted, for example, on a vehicle. The authentication apparatus 110 includes an image acquisition unit 111, a face detection unit 112, a face information storage unit 113, and a collation unit 114. The authentication apparatus 110 is formed, for example, as an apparatus including one or more processors and one or more memories. At least some of the functions of each part inside the authentication apparatus 110 may be implemented by a processor executing processing according to the program loaded from the memory. The authentication apparatus 110 corresponds to the authentication apparatus 20 shown in FIG. 1.

The image acquisition unit 111 acquires a video image (image) captured by the camera 130. The image acquisition unit 111 sequentially acquires the latest image data captured by the camera 130. The face detection unit 112 detects a face area (face image) from the image data acquired by the image acquisition unit 111. The face detection unit 112 corresponds to the face image acquisition means 21 shown in FIG. 1.

The face information storage unit 113 stores face information of each of one or more users (registrants) to be authenticated. Each user registers the face image of himself/herself in the authentication apparatus 110. The face information storage unit 113 stores the registered face image as a master. The face image registered by the user is also referred to as a registered image. The face information storage unit 113 may store, in addition to or in place of the registered image, features extracted from the registered image as a master.

The face information storage unit 113 stores, for each user, besides the registered image, a face image of the subject which has been successfully authenticated. When, for example, it is identified that the subject is a user who has been successful in face authentication, the face information storage unit 113 stores the face image detected in the face detection unit 112 as the face image which has been successfully authenticated in the past. The face information storage unit 113 stores, for each user, for example, the face image which has been successfully authenticated in the latest face authentication. The face image stored in the face information storage unit 113 which has been successfully authenticated is not limited to the face image which has been successfully authenticated in the latest face authentication. The face information storage unit 113 may store, for each user, for example, a face image which has been successfully authenticated in a multiple times of face authentication in the past.

Note that the face information storage unit 113 may not be necessarily included in the authentication apparatus 20. The face information storage unit 113 may be formed using, for example, a storage device connected to the authentication apparatus 20 via a network. The face information storage unit 113 corresponds to the face information storage unit 23 shown in FIG. 1.

The collation unit 114 authenticates the face of the person to be authenticated using the face image detected in the face detection unit 112. The face authentication performed by the collation unit 114 includes a first face authentication (first authentication) and a second face authentication (second authentication). The collation unit 114 collates the face image detected by the face detection unit 112 with the registered image registered in the face information storage unit 113 in the first face authentication. In the first face authentication, the collation unit 114 acquires the registered image of each user from the face information storage unit 113. The collation unit 114 collates the face image detected by the face detection unit 112 with the registered image of each user that has been acquired. The collation unit 114 extracts, for example, features of the face from the face image detected by the face detection unit 112 and compares the extracted features with the features extracted from the registered image.

The collation unit 114 calculates a collation score indicating a degree of match between the face image of the subject and the registered image or a degree of similarity between them. In the following description, the higher the degree of match or the degree of similarity, the higher the collation score is. The collation unit 114 calculates the collation score for each of one or more users. The collation unit 114 determines whether or not the first face authentication has been successful based on the collation score. The collation unit 114 compares, for example, the collation score calculated for each user with a first threshold and determines whether or not the first face authentication has been successful based on the result of the comparison.

When, for example, the score of the collation between the face image of the subject and the registered image of one user is equal to or larger than the first threshold, the collation unit 114 determines that the first face authentication is successful. When the first face authentication is successful, the collation unit 114 identifies that the subject is a registrant who has the highest collation score. The collation unit 114 stores, when the first face authentication is successful, the face image detected in the face detection unit 112 in the face information storage unit 113 as a face image which has been successfully authenticated. When the face information storage unit 113 already stores the face image which has been successful in face authentication, the face information storage unit 113 may overwrite the face image which has been successfully authenticated with the face image which has been successfully authenticated in the latest face authentication. The collation unit 114 may store, in addition to the face image or in place of the face image, the features extracted from the face image in the face information storage unit 113.

When the collation score is smaller than the first threshold, the collation unit 114 determines that the first face authentication has failed. In this case, the collation unit 114 executes the second face authentication using the face image stored in the face information storage unit 113 which has been successfully authenticated. In the second face authentication, the collation unit 114 acquires the face image or features regarding which the first face authentication has been successful in the past from the face information storage unit 113. The collation unit 114 collates the face image of the subject or the features thereof with the registered image of each of one or more users or the features thereof, and the acquired face image which has been successfully authenticated in the past or the features thereof.

In the second face authentication, the collation unit 114 acquires the face image which has been successfully authenticated from the face information storage unit 113 based on the collation score of each user in the first face authentication. The collation unit 114 specifies, for example, a user who has a high collation score in the first face authentication and acquires the face image of a particular user which has been successfully authenticated in the past from the face information storage unit 113. The collation unit 114 temporarily adds, in the second face authentication, the acquired face image which has been successfully authenticated in the past to the registered image, and collates the registered image and the face image which has been successfully authenticated in the past with the face image of the subject.

The collation unit 114 calculates, in the second face authentication, the collation score for each user to be collated. The method for calculating the collation score in the second face authentication may be the same as the method for calculating the collation score in the first face authentication. The collation unit 114 determines whether or not the second face authentication has been successful based on the calculated collation score. When the score of collation with the registered image of any user or the face image which has been successfully authenticated in the past is equal to or larger than the first threshold, the collation unit 114 determines that the second face authentication has been successful. The collation unit 114 corresponds to the authentication means 22 shown in FIG. 1.

The authentication apparatus 110 outputs the result of the authentication to equipment (not shown) such as an Electronic Control Unit (ECU) that controls vehicles. When the subject is authenticated as a user registered in advance, the ECU unlocks the door of the vehicle and allows the user to get on the vehicle. When the subject is not authenticated as a user registered in advance, the ECU does not unlock the door of the vehicle.

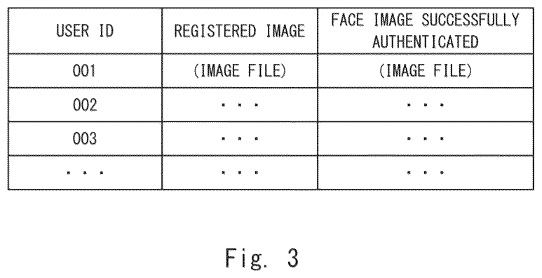

FIG. 3 shows an example of the face information stored in the face information storage unit 113. In FIG. 3, a user Identifier (ID) indicates an ID for identifying each user. The face information storage unit 113 stores, regarding each user, the registered image and the face image which has been successfully authenticated in the past. The registered image may be an image captured using the camera 130 or may be an image captured using an image-capturing device other than the camera 130. On the other hand, the face image which has been successfully authenticated in the past is an image captured by the camera 130 when the first face authentication has been successful.

In the first face authentication, the collation unit 114 collates the face image detected in the face detection unit 112 with the registered image of each user registered in the face information storage unit 113. The collation unit 114 specifies, for example, the user ID that corresponds to the registered image having the highest score of the collation with the face image detected in the face detection unit 112. When the collation score is equal to or larger than the first threshold, the collation unit 114 determines that the first face authentication has been successful. In this case, the collation unit 114 identifies that the subject is the user identified with the specified user ID.

When the first face authentication has failed, that is, when the collation score is smaller than the first threshold, the collation unit 114 performs the second face authentication. In the second face authentication, the collation unit 114 acquires the face image which has been successfully authenticated in the past and which corresponds to the specified user ID from the face information storage unit 113. In the second face authentication, the collation unit 114 collates the face image detected in the face detection unit 112 with the registered image of each user and the face image which has been successfully authenticated in the past and which corresponds to the specified user ID.

The collation unit 114 specifies, in the second face authentication, the user ID that corresponds to the registered image having the highest score of the collation with the face image detected in the face detection unit 112 or the face image which has been successfully authenticated in the past. When the collation score is equal to or larger than the first threshold, the collation unit 114 determines that the second face authentication has been successful. In this case, the collation unit 114 identifies that the subject is a user identified with the specified user ID.

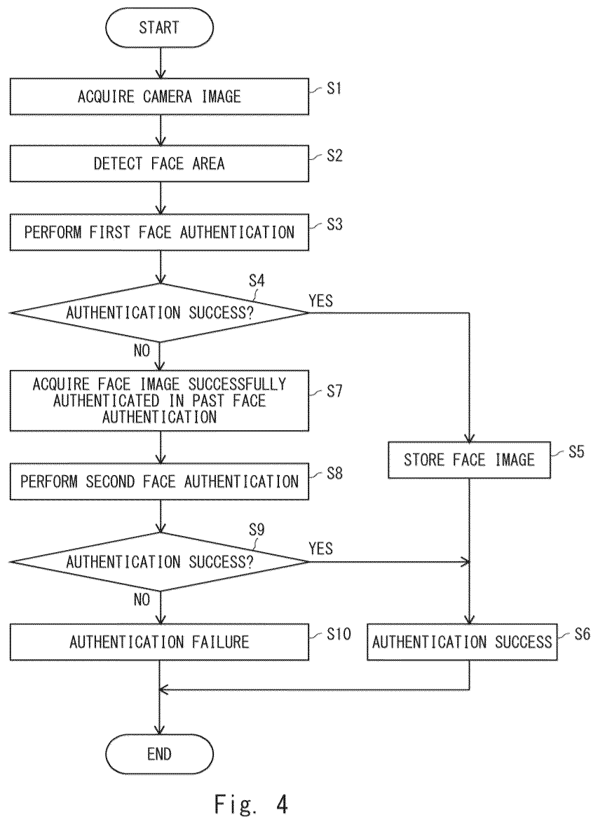

Next, an operation procedure will be described. FIG. 4 shows an operation procedure (authentication method) in the authentication apparatus 110. The image acquisition unit 111 acquires a camera image from the camera 130 (Step S1). The image acquisition unit 111 periodically performs Step S1 and acquires a camera image in a time-sequential manner from the camera 130 that captures a moving image. The face detection unit 112 detects a face area from the camera image acquired by the image acquisition unit 111 (Step S2). The face detection unit 112 outputs an image (face image) of the face area detected in Step S2 to the collation unit 114.

The collation unit 114 performs the first face authentication on the face image input from the face detection unit 112 (Step S3). In the first face authentication, the collation unit 114 collates the face image input from the face detection unit 112 with each of the registered images registered in the face information storage unit 113. The collation unit 114 calculates, for each registered image, a score of the collation with the face image input from the face detection unit 112. The collation unit 114 determines, based on the calculated collation score, whether or not the first face authentication has been successful (Step S4). The collation unit 114 compares, in Step S4, the collation score calculated for each registered image with the first threshold and determines whether or not the collation score is equal to or larger than the first threshold.

When the collation score is equal to or larger than the first threshold, the collation unit 114 determines that the first face authentication has been successful in Step S4. When it is determined that the first face authentication has been successful, the collation unit 114 stores the face image collated with the registered image in the face information storage unit 113 as the face image which has been successfully authenticated in the past (Step S5). Further, the collation unit 114 outputs a message indicating that the face authentication has been successful (Step S6). The collation unit 114 also outputs, in Step S6, the user ID that corresponds to the registered image having the highest score of the collation with the face image input from the face detection unit 112.

When the collation score is smaller than the first threshold, the collation unit 114 determines that the first face authentication has failed in Step S4. In this case, the collation unit 114 acquires, from the face information storage unit 113, a face image which has been successfully authenticated in the past face authentication (Step S7). The collation unit 114 acquires, in Step S7, the face image which has been successfully authenticated in the past and which corresponds to the user having the highest collation score calculated in the first face authentication.

The collation unit 114 performs the second face authentication on the face image input from the face detection unit 112 (Step S8). The collation unit 114 collates, in the second face authentication, the face image input from the face detection unit 112 with each registered image of each user and the face image acquired in Step S7. The collation unit 114 calculates, regarding each registered image and the face image acquired in Step S7, the score of the collation with the face image input from the face detection unit 112.

The collation unit 114 determines whether or not the second face authentication has been successful based on the calculated collation score (Step S9). In Step S9, the collation unit 114 compares the collation score calculated for each registered image and the face image acquired in Step S7 with the first threshold to determine whether or not the collation score is equal to or larger than the first threshold. When the collation score is equal to or larger than the first threshold, the collation unit 114 determines that the second face authentication has been successful. In this case, the collation unit 114 proceeds to Step S6 and outputs a message indicating that the face authentication has been successful.

When the collation score is smaller than the first threshold, the collation unit 114 determines that the second face authentication has failed in Step S9. In this case, the collation unit 114 outputs a message indicating that the face authentication has failed (Step S10). When the second face authentication has failed, the authentication apparatus 110 may return to Step S1, where the face authentication may be performed again from the beginning.

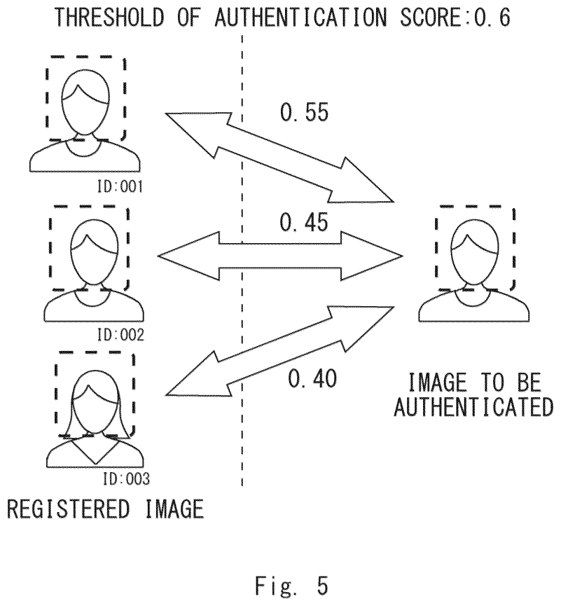

Hereinafter, the first face authentication and the second face authentication will be described with specific examples. FIG. 5 schematically shows the first face authentication. In FIG. 5, the image to be authenticated shows the face image of the subject detected by the face detection unit 112. The three registered images indicate registered images of users with user IDs: 001, 002, and 003 registered in the face information storage unit 113.

The collation unit 114 calculates a score of collation between the image to be authenticated and each of the three registered images. It is assumed, in FIG. 5, that the score of the collation between the image to be authenticated and the registered image of the user with the user ID: 001 is 0.55. It is also assumed that the score of the collation between the image to be authenticated and the registered image of the user with the user ID: 002 is 0.45. It is also assumed that the score of the collation between the image to be authenticated and the registered image of the user with the user ID: 003 is 0.40. In this example, the score of the collation between the image to be authenticated and the registered image of the user with ID: 001 is the highest.

It is assumed, in the example shown in FIG. 5, that a threshold of the authentication score (first threshold) for determining whether or not the face authentication has been successful is 0.6. The collation unit 114 determines whether or not the collation score is equal to or larger than the threshold of the authentication score. In this example, the collation score of each registered image is smaller than the threshold of the authentication score. Accordingly, the collation unit 114 determines that the first face authentication has failed.

If the collation score of the registered image of the user with the user ID: 001 is equal to or larger than the threshold of the authentication score, the collation unit 114 determines that the first face authentication has been successful and identifies that the subject is a user with the user ID: 001. In this case, the collation unit 114 stores, in the face information storage unit 113, the image to be authenticated which has been collated with the registered image as a face image of the user with the user ID: 001 which has been successfully authenticated in the past.

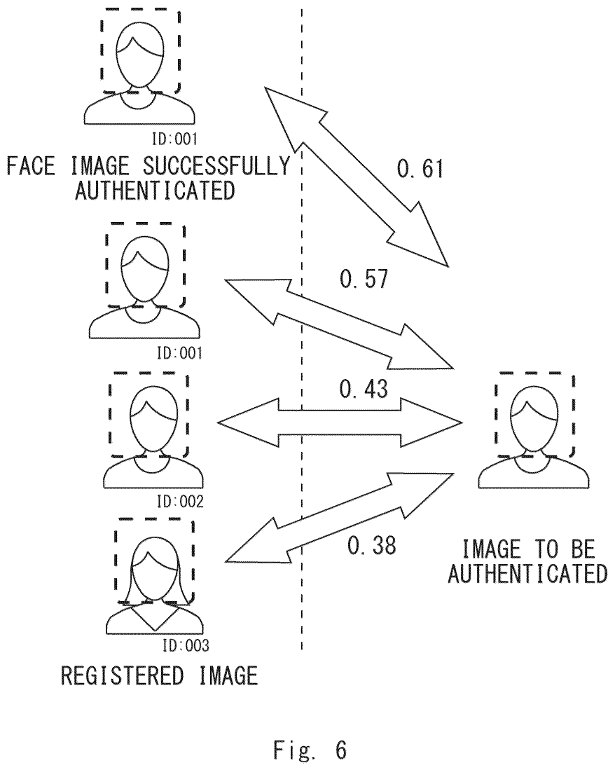

FIG. 6 schematically shows the second face authentication. When the first face authentication has failed, the collation unit 114 acquires, from the face information storage unit 113, a face image which has been successfully authenticated in the previous face authentication of the user with the user ID: 001 who has the highest collation score in the first face authentication. In the second face authentication, the collation unit 114 calculates a score of a collation between the image to be authenticated acquired at the timing when the second face authentication is performed and each of the three registered images. Further, the collation unit 114 calculates the score of the collation between the image to be authenticated and the face image of the user with the user ID: 001 which has been successfully authenticated in the previous face authentication.

It is assumed, in FIG. 6, that the score of the collation between the image to be authenticated with the registered image of the user with the user ID: 001 is 0.57. It is further assumed that the score of the collation between the image to be authenticated and the registered image of the user with the user ID: 002 is 0.43. It is assumed that the score of the collation between the image to be authenticated and the registered image of the user with the user ID: 003 is 0.38. It is further assumed that the score of the collation between the image to be authenticated and the face image of the user ID: 001 which has been successfully authenticated in the previous face authentication is 0.61. In this example, the score of the collation between the image to be authenticated and the face image of the user ID: 001 which has been successfully authenticated in the previous face authentication exceeds the threshold of the authentication score. Accordingly, in the second face authentication, the subject is identified to be the user with user ID: 001.

It can be considered that, when the authentication system 100 is used for vehicle interior entry, an environment in which an image is captured by the camera 130 is different from an environment in which an image is captured as a registered image. In particular, when the camera 130 captures an image of a subject who is outdoors, even when the subject is a registered user, it is possible that face authentication may fail depending on the lighting environment or the like around the camera 130.

In this example embodiment, the collation unit 114 collates the face image of the subject with the registered image of each user in the first face authentication. When the first face authentication has been successful, the collation unit 114 stores the face image of the user captured using the camera 130 in the face information storage unit 113 as the face image which has been successfully authenticated. In this example embodiment, the face information storage unit 113 stores, for example, the face image which has been successfully authenticated in the latest face authentication for each user. This face image is an image captured using the camera 130. When the first face authentication has failed, the collation unit 114 collates, in the second face authentication, the face image of the subject with the face image which has been successfully authenticated in the past and is stored in the face information storage unit 113.

In this example embodiment, in the second face authentication, the collation unit 114 temporarily adds the face image which has been successfully authenticated in the past to the collation target. In the second face authentication, the face image of the subject is collated with the face image captured using the camera 130. In the second face authentication, face images captured using one camera 130 are collated with each other, from which it is considered that the probability that the face authentication is successful will be higher than that in the first face authentication. If the face image of the subject is always collated with the registered image of each user and the face image which has been successfully authenticated in the past, the number of times collation has to be performed increases although the probability that authentication is successful can be made high. In contrast, in this example embodiment, when the first face authentication has failed, the face image which has been successfully authenticated in the past is temporarily used. Accordingly, according to this example embodiment, it is possible to reduce the probability of authentication failure while preventing the number of times collation has to be performed from increasing compared to the case in which an image which has been successfully authenticated in the past is always used.

In the aforementioned example embodiment, the example in which the face image of the user having the highest collation score in the first face authentication which has been successfully authenticated in the past is acquired has been described. However, it can be considered that, when a collation score is low, the probability that the subject is the user having the highest collation score is low. In view of this case, when the difference between the collation score in the first face authentication and the first threshold used to determine whether or not authentication is successful is equal to or smaller than a certain value, the collation unit 114 may acquire the face image of the user having the highest collation score which has been successfully authenticated in the past and execute the second face authentication. In other words, the collation unit 114 may compare the maximum value of the collation score in the first face authentication with a second threshold smaller than the first threshold and acquire, when the collation score is equal to or larger than the second threshold, the face image of the user having the highest collation score which has been successfully authenticated in the past. When the maximum value of the collation score is smaller than the second threshold, the collation unit 114 may perform the first face authentication again without executing the second face authentication.

Further, in the aforementioned example embodiment, the example in which the collation unit 114 performs, in the second face authentication, a collation with the face image which has been successfully authenticated in the past in addition to the registered image collated in the first face authentication has been described. However, it is considered that a registered image having a low collation score in the first face authentication is a registered image of a person different from the subject, and thus it is considered that the collation score in the second face authentication is low as well. In the second face authentication, there is no need to perform a collation with the face image of the subject for all the registered images. Registered images of users having low collation scores may be excluded from the collation in the second face authentication. The collation unit 114 compares, for example, the collation score calculated in the first face authentication with a third threshold smaller than the first threshold. The third threshold may be different from the second threshold or may be same as the second threshold. The third threshold may be larger than the second threshold or may be smaller than the second threshold. The collation unit 114 may collate a registered image whose collation score in the first face authentication is equal to or larger than the third threshold with the face image of the subject in the second face authentication. In this case, it is possible to reduce the number of times collation has to be performed in the second face authentication and reduce a time required for authentication processing.

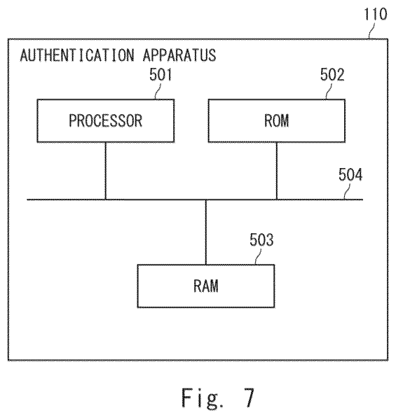

Next, a hardware configuration of the authentication apparatus 110 will be described. FIG. 7 shows an example of a hardware configuration of the authentication apparatus 110. The authentication apparatus 110 includes a processor (CPU: Central Processing Unit) 501, a read only memory (ROM) 502, and a random access memory (RAM) 503. In the authentication apparatus 110, the processor 501, the ROM 502, and the RAM 503 are connected to one another via a bus 504. The authentication apparatus 110 may include other circuits such as a peripheral circuit, a communication circuit, and an interface circuit, although they are not illustrated.

The ROM 502 is a non-volatile storage device. The ROM 502 may be, for example, a semiconductor storage device such as a flash memory with a relatively low capacity. The ROM 502 stores a program that executes the processor 501.

The aforementioned program includes instructions (or software codes) that, when loaded into a computer, cause the computer to perform one or more of the functions described in the example embodiment. The program may be stored in a non-transitory computer readable medium or a tangible storage medium. By way of example, and not a limitation, non-transitory computer readable media or tangible storage media can include a RAM, a ROM, a flash memory, a solid-state drive (SSD) or other types of memory technologies, a Compact Disc (CD), a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The RAM 503 is a volatile storage device. The RAM 503 may be various semiconductor memory devices such as a Dynamic Random Access Memory (DRAM) or a Static Random Access Memory (SRAM). The RAM 503 may be used as an internal buffer that temporarily stores data or the like.

The processor 501 deploys the program stored in the ROM 502 in the RAM 503 and executes the deployed program. The CPU 501 executes the program, whereby functions of the respective units in the authentication apparatus 110 may be implemented.

Note that the authentication apparatus 110 may not necessarily be a single apparatus. The authentication apparatus 110 may be configured using a plurality of apparatuses physically separated from each other. Further, in the case in which the authentication apparatus 110 is used for vehicle interior entry, not all the functions of the authentication apparatus 110 need to be installed in the vehicle. For example, each unit of the authentication apparatus 110 may be disposed in the outside of the vehicle. In this case, the authentication apparatus 110 may acquire an image captured by the camera 130 via a wireless communication network. The authentication apparatus 110 may transmit the result of the authentication to the vehicle via the wireless communication network.

While the example embodiment of the present disclosure has been described in detail, the present disclosure is not limited to the aforementioned example embodiment and various changes or modifications of the aforementioned example embodiment without departing from the spirit of the present disclosure may also be included in the present disclosure.

For example, the whole or part of the example embodiments disclosed above can be described as, but not limited to, the following supplementary notes.

### [Supplementary Note 1]

An authentication apparatus comprising:
face image acquisition means for acquiring, from a captured image acquired from an image-capturing device that captures an image of a person to be
authenticated, a face image of the person to be authenticated; and authentication means for performing a first authentication for collating the acquired face image of the person to be authenticated or features extracted from the face image with a registered image of a registrant or features extracted from the registered image,
wherein the authentication means stores, when the first authentication has been successful, the face image of the person to be authenticated or the features extracted from the face image in a face information storage unit as face information regarding which authentication of the registrant has been successful, and performs, when the first authentication has failed, a second authentication including collating the face image of the person to be authenticated or the features extracted from the face image with face information regarding which the authentication has been successful and which is stored in the face information storage unit.

### [Supplementary Note 2]

The authentication apparatus according to Supplementary Note 1, wherein the authentication means collates, in the first authentication, the face image of the person to be authenticated or the features extracted from the face image with the registered image of each of one or more registrants or features extracted from each of the registered images.

### [Supplementary Note 3]

The authentication apparatus according to Supplementary Note 2, wherein the authentication means calculates, in the first authentication, for each of the one or more registrants, a collation score indicating a degree of match between the face image of the person to be authenticated and the registered image, compares the calculated authentication score with a first threshold, and determines whether or not the first authentication has been successful based on the result of the comparison.

### [Supplementary Note 4]

The authentication apparatus according to Supplementary Note 3, wherein the authentication means determines, when a collation score of a registrant who has the highest collation score is equal to or larger than the first threshold, that the first authentication has been successful and determines, when the collation score of the registrant who has the highest collation score is smaller than the first threshold, that the first authentication has failed.

### [Supplementary Note 5]

The authentication apparatus according to Supplementary Note 4, wherein the authentication means identifies, when the first authentication has been successful, that the person to be authenticated is the registrant who has the highest collation score.

### [Supplementary Note 6]

The authentication apparatus according to any one of Supplementary Notes 3 to 5, wherein in the second authentication, the authentication means acquires, based on the authentication score of each registrant in the first authentication, face information regarding which the authentication has been successful from the face information storage unit, and collates the acquired face information with the face image of the person to be authenticated or the features extracted from the face image.

### [Supplementary Note 7]

The authentication apparatus according to Supplementary Note 6, wherein the authentication means acquires, from the face information storage unit, face information of a registrant who has the highest collation score in the first authentication regarding which the authentication has been successful.

### [Supplementary Note 8]

The authentication apparatus according to Supplementary Note 7, wherein the authentication means compares, when the first authentication has failed, the collation score of the registrant who has the highest collation score in the first authentication with a second threshold smaller than the first threshold, and acquires, when the collation score of the registrant who has the highest collation score is equal to or larger than the second threshold, face information regarding which the authentication has been successful from the face information storage unit.

### [Supplementary Note 9]

The authentication apparatus according to Supplementary Note 8, wherein the authentication means performs, when the collation score of the registrant who has the highest collation score is smaller than the second threshold, the first authentication again.

### [Supplementary Note 10]

The authentication apparatus according to any one of Supplementary Notes 2 to 9, wherein the authentication means collates, in the second authentication, the face image of the person to be authenticated or the features extracted from the face image with the registered image of each of one or more registrants or features extracted from each of the registered images, and face information regarding which the authentication has been successful.

### [Supplementary Note 11]

The authentication apparatus according to any one of Supplementary Notes 3 to 9, wherein the authentication means collates, in the second authentication, the face image of the person to be authenticated or the features extracted from the face image with a registered image of a registrant among the one or more registrants whose collation score in the first authentication is equal to or larger than a third threshold which is smaller than the first threshold or features extracted from the registered image, and face information regarding which the authentication has been successful.

### [Supplementary Note 12]

The authentication apparatus according to any one of Supplementary Notes 1 to 11, wherein the captured image is an image obtained by capturing an image of a person to be authenticated who is outdoors.

### [Supplementary Note 13]

An authentication system comprising:
an image-capturing device that captures an image of a person to be authenticated; and
an authentication apparatus configured to acquire the image captured by the image-capturing device and authenticate the person to be authenticated, wherein
the authentication apparatus comprises:
   face image acquisition means for acquiring a face image of the person to be authenticated from the captured image; and
   authentication means for performing a first authentication for collating the acquired face image of the person to be authenticated or features extracted from the face image with a registered image of a registrant or features extracted from the registered image, and
the authentication means stores, when the first authentication has been successful, the face image of the person to be authenticated or the features extracted from the face image in a face information storage unit as face information regarding which authentication of the registrant has been successful, and performs, when the first authentication has failed, a second authentication including collating the face image of the person to be authenticated or the features extracted from the face image with face information regarding which the authentication has been successful and which is stored in the face information storage unit.

### [Supplementary Note 14]

The authentication system according to Supplementary Note 13, wherein the authentication means collates, in the first authentication, the face image of the person to be authenticated or the features extracted from the face image with the registered image of each of one or more registrants or features extracted from each of the registered images.

### [Supplementary Note 15]

The authentication system according to Supplementary Note 14, wherein the authentication means calculates, in the first authentication, for each of the one or more registrants, a collation score indicating a degree of match between the face image of the person to be authenticated and the registered image, compares the calculated authentication score with a first threshold, and determines whether or not the first authentication has been successful based on the result of the comparison.

### [Supplementary Note 16]

The authentication system according to Supplementary Note 14 or 15, wherein the authentication means collates, in the second authentication, the face image of the person to be authenticated or the features extracted from the face image with the registered image of each of one or more registrants or features extracted from each of the registered images, and face information regarding which the authentication has been successful.

### [Supplementary Note 17]

An authentication method comprising:
acquiring a face image of a person to be authenticated from a captured image acquired from an image-capturing device that captures an image of the person to be authenticated;
performing a first authentication for collating the acquired face image of the person to be authenticated or features extracted from the face image with a registered image of a registrant or features extracted from the registered image;
determining whether or not the first authentication has been successful;
storing, when it is determined that the first authentication has been successful, the face image of the person to be authenticated or the features extracted from the face image in a face information storage unit as face information regarding which authentication of the registrant has been successful; and
performing, when it is determined that the first authentication has failed, a second authentication including collating the face image of the person to be authenticated or the features extracted from the face image with face information regarding which the authentication has been successful and which is stored in the face information storage unit.

### [Supplementary Note 18]

A non-transitory computer readable medium storing a program for causing a computer to execute processing including:
acquiring a face image of a person to be authenticated from a captured image acquired from an image-capturing device that captures an image of the person to be authenticated;
performing a first authentication for collating the acquired face image of the person to be authenticated or features extracted from the face image with a registered image of a registrant or features extracted from the registered image;
determining whether or not the first authentication has been successful;
storing, when it is determined that the first authentication has been successful, the face image of the person to be authenticated or the features extracted from the face image in a face information storage unit as face information regarding which authentication of the registrant has been successful; and
performing, when it is determined that the first authentication has failed, a second authentication including collating the face image of the person to be authenticated or the features extracted from the face image with face information regarding which the authentication has been successful and which is stored in the face information storage unit.

### REFERENCE SIGNS LIST

10: AUTHENTICATION SYSTEM
20: AUTHENTICATION APPARATUS
21: FACE IMAGE ACQUISITION MEANS
22: AUTHENTICATION MEANS
30: IMAGE-CAPTURING DEVICE
100: AUTHENTICATION SYSTEM
110: AUTHENTICATION APPARATUS
111: IMAGE ACQUISITION UNIT
112: FACE DETECTION UNIT
113: FACE INFORMATION STORAGE UNIT
114: COLLATION UNIT
130: CAMERA
501: PROCESSOR
502: ROM
503: RAM
504: BUS

What is claimed is:

1. An authentication apparatus comprising:
at least one memory storing instructions; and
at least one processor configured to execute the instructions to:
acquire, from a captured image acquired from an image-capturing device that captures an image of a person to be authenticated, a face image of the person to be authenticated;
perform a first authentication for collating the acquired face image of the person to be authenticated or features extracted from the face image with a registered image of a registrant or features extracted from the registered image;
store, when the first authentication has been successful, the face image of the person to be authenticated or the features extracted from the face image in a face information storage as face information regarding which authentication of the registrant has been successful; and
perform, when the first authentication has failed, a second authentication including collating the face image of the person to be authenticated or the features extracted from the face image with face information regarding which the authentication has been successful and which is stored in the face information storage.

2. The authentication apparatus according to claim 1, wherein the at least one processor is configured to execute the instructions to collate, in the first authentication, the face image of the person to be authenticated or the features extracted from the face image with the registered image of each of one or more registrants or features extracted from each of the registered images.

3. The authentication apparatus according to claim 2, wherein the at least one processor is configured to execute the instructions to calculate, in the first authentication, for each of the one or more registrants, a collation score indicating a degree of match between the face image of the person to be authenticated and the registered image, compare the calculated collation score with a first threshold, and determine whether or not the first authentication has been successful based on the result of the comparison.

4. The authentication apparatus according to claim 3, wherein the at least one processor is configured to execute the instructions to determine, when a collation score of a registrant who has the highest collation score is equal to or larger than the first threshold, that the first authentication has been successful and determine, when the collation score of the registrant who has the highest collation score is smaller than the first threshold, that the first authentication has failed.

5. The authentication apparatus according to claim 4, wherein the at least one processor is configured to execute the instructions to identify, when the first authentication has been successful, that the person to be authenticated is the registrant who has the highest collation score.

6. The authentication apparatus according to claim 1, wherein in the second authentication, the at least one processor is configured to execute the instructions to acquire, based on the collation score of each registrant in the first authentication, face information regarding which the authentication has been successful from the face information storage, and collate the acquired face information with the face image of the person to be authenticated or the features extracted from the face image.

7. The authentication apparatus according to claim 6, wherein the at least one processor is configured to execute the instructions to acquire, from the face information storage, face information of a registrant who has the highest collation score in the first authentication regarding which the authentication has been successful.

8. The authentication apparatus according to claim 7, wherein the at least one processor is configured to execute the instructions to compare, when the first authentication has failed, the collation score of the registrant who has the highest collation score in the first authentication with a second threshold smaller than the first threshold, and acquire, when the collation score of the registrant who has the highest collation score is equal to or larger than the second threshold, face information regarding which the authentication has been successful from the face information storage.

9. The authentication apparatus according to claim 8, wherein the at least one processor is configured to execute the instructions to perform, when the collation score of the registrant who has the highest collation score is smaller than the second threshold, the first authentication again.

10. The authentication apparatus according to claim 2, wherein the at least one processor is configured to execute the instructions to collate, in the second authentication, the face image of the person to be authenticated or the features extracted from the face image with the registered image of each of one or more registrants or features extracted from each of the registered images, and face information regarding which the authentication has been successful.

11. The authentication apparatus according to claim 3, wherein the at least one processor is configured to execute the instructions to collate, in the second authentication, the face image of the person to be authenticated or the features extracted from the face image with a registered image of a registrant among the one or more registrants whose collation score in the first authentication is equal to or larger than a third threshold which is smaller than the first threshold or features extracted from the registered image, and face information regarding which the authentication has been successful.

12. The authentication apparatus according to claim 1, wherein the captured image is an image obtained by capturing an image of a person to be authenticated who is outdoors.

13. An authentication system comprising:
an image-capturing device that captures an image of a person to be authenticated; and
the authentication apparatus according to claim 1.

14. The authentication system according to claim 13, wherein the at least one processor is configured to execute the instructions to collate, in the first authentication, the face image of the person to be authenticated or the features extracted from the face image with the registered image of each of one or more registrants or features extracted from each of the registered images.

15. The authentication system according to claim 14, wherein the at least one processor is configured to execute the instructions to calculate, in the first authentication, for each of the one or more registrants, a collation score indicating a degree of match between the face image of the person to be authenticated and the registered image, compare the calculated collation score with a first threshold, and determine whether or not the first authentication has been successful based on the result of the comparison.

16. The authentication system according to claim 14, wherein the at least one processor is configured to execute the instructions to collate, in the second authentication, the face image of the person to be authenticated or the features extracted from the face image with the registered image of each of one or more registrants or features extracted from each of the registered images, and face information regarding which the authentication has been successful.

17. An authentication method comprising:
acquiring a face image of a person to be authenticated from a captured image acquired from an image-capturing device that captures an image of the person to be authenticated;
performing a first authentication for collating the acquired face image of the person to be authenticated or features extracted from the face image with a registered image of a registrant or features extracted from the registered image;
determining whether or not the first authentication has been successful;
storing, when it is determined that the first authentication has been successful, the face image of the person to be authenticated or the features extracted from the face image in a face information storage as face information regarding which authentication of the registrant has been successful; and
performing, when it is determined that the first authentication has failed, a second authentication including collating the face image of the person to be authenticated or the features extracted from the face image with face information regarding which the authentication has been successful and which is stored in the face information storage.

18. A non-transitory computer readable medium storing a program for causing a computer to execute processing including:
acquiring a face image of a person to be authenticated from a captured image acquired from an image-capturing device that captures an image of the person to be authenticated;
performing a first authentication for collating the acquired face image of the person to be authenticated or features extracted from the face image with a registered image of a registrant or features extracted from the registered image;
determining whether or not the first authentication has been successful;
storing, when it is determined that the first authentication has been successful, the face image of the person to be authenticated or the features extracted from the face image in a face information storage as face information regarding which authentication of the registrant has been successful; and
performing, when it is determined that the first authentication has failed, a second authentication including collating the face image of the person to be authenticated or the features extracted from the face image with face information regarding which the authentication has been successful and which is stored in the face information storage.
